(19) United States
(12) Patent Application Publication
(10) Pub. No.: US 2004/0055820 A1
(43) Pub. Date: Mar. 25, 2004

(54) Ladder safety device

(76) Inventor: Robert Francis Charlton, Queensland (AU)

Correspondence Address: Robert J Sacco, Sacco & Associates, P O Box 30999, Palm Beach Gardens, FL, 33420-0999, US

(21) Appl. No.: 10/470,358

(22) PCT Filed: Jan. 23, 2002
(86) PCT No.: PCT/AU02/00071

(30) Foreign Application Priority Data
Jan. 24, 2001 (AU) PR 2671

(51) Int. Cl. E06C 7/42

(52) U.S. Cl. 182/107

(57) ABSTRACT

A ladder stabilising device (10) comprising first (11) and second clamp (13,52) members joined by connection member (12,51) in the form of a flexible cable or strap (12,51). The first member (11) may be clamped to a building, a post or the like. The connection member (12) is wrapped around a rail (30) or rung (29) of the ladder and the second clamp member (13) is fixed to the building or to the ladder. In a preferred embodiment the second clamp member (52) is adapted to slide along a ladder rail (54) to be releasably locked (58) into a preferred position. The second clamp member (52) may be a slotted sleeve (52) or adapted to slide along a slot and rail arrangement (54). The device may include a tensioning arrangement (61,62) to tension the connection member (51). A method of stabilising a ladder is also disclosed.

### FIELD OF THE INVENTION

This invention relates to an apparatus and method for increasing the safety of ladder use. In particular the invention relates to an apparatus and method for holding a ladder in a secure and generally safe position while in use.

### BACKGROUND OF THE INVENTION

Ladders are notorious for being the focal point of life threatening accidents in both domestic and industrial settings. The element of risk may be increased by the nature of the ladder, its length in use, the stability of the ground support surface and the nature and shape of the support structure at its upper end.

In the absence of a level base surface, a ladder will often adopt a laterally sloped attitude. The effect of this slope is to move the centre of gravity of the ladder and user away from the rung support structure and, in some cases, to a point outside a lateral rail of the ladder. At this stage, the user is essentially relying on frictional engagement between the top end of the ladder and a support structure to prevent the ladder sliding sideways. In another respect, danger arises when a ladder is particularly steeply sloped and approaching the vertical in a front to back direction. In this circumstance, it is possible for the ladder to disengage from its support surface and tilt backwards carrying the user into a radially arcing fall away from the support surface.

The relative experience of a user may also be important in the risk factors of a ladder with home handymen being particularly susceptible to accidents, although this may be offset by industrial use which often occurs in more challenging environments.

It would be advantageous to provide a ladder stabilising or securing apparatus which tended to counteract at least some of the instability of a ladder during use.

### SUMMARY OF THE INVENTION

Throughout this specification, unless the context requires otherwise, the word “comprise”, or variations such as “comprises” or “comprising”, will be understood to imply the inclusion of a stated element or integer or group of elements or integers but not the exclusion of any other element or integer or group of elements or integers.

In a first aspect the invention resides in a ladder stabilising device comprising:

first engagement means adapted to releasably engage a first structure;

a connection member connected to the first engagement means; and

second engagement means adapted to engage the first structure or a second structure, the second engagement means connected to the connection member at a position spaced from the first engagement means.

Preferably the first engagement means is clamping means. Suitably the clamping means is an adjustable clamping member. The clamping member may comprise opposed jaws, movable relative to each other. The opposed jaws may be resiliently biased to a closed position. The clamping member may include screw threaded adjusting means for adjusting the laws relative to each other.

The clamping means may also suitably include locking means for locking the jaws in pressured contact with the first structure. The locking means may be a lover activated over-centre locking device.

The first and second engagement means may be formed of metal, plastic, rubber or other suitable material. The second engagement means is preferably adapted to releasibly engage the first or second structure.

The first structure may be a building or feature thereof. The first structure may be a gutter of the building. The first structure may be any one of a post, cable, wire or other suitable supportive structure. The first structure may be the ladder itself. The second structure may be any suitable alternative support structure other then the first structure.

The ladder stabilising device may include a lateral support member for providing lateral support to the ladder. The lateral support member may be formed integrally as part of one of the jaws. Alternatively the lateral support member may be releasably engageable with the jaw. The lateral support member may be adapted to bracket a ladder side rail. A gap provided for bracketing the ladder side rail may be adjustable. The lateral support member may be a bracket formed from a plate member. Alternatively the lateral support member may be a bracket formed of elongate material such as wire.

The lateral support member may be adjustably engaged with the jaw of the clamping member to facilitate variation of the bracket space provided to received the ladder rail.

Alternatively, the first engagement means may be a u shaped member adapted to locate over the first structure or feature thereof. The u shaped member may have locking means for fixing the u shaped member to the gutter. The looking means may be a screw operated locking means.

The connection member may be rigid or semi-flexible. The connection member is preferably flexible throughout its length. The connection member may be semi-flexible. The flexible member may be formed from a strap, webbing, chain or rope or other suitable material. The connection member may be formed of rod section with locking bell joints or hinges. The connection member may be formed from an elasticised or rubberised, material.

The connection member may be permanently connected to the first engagement means and second engagement means or alternatively releasably connected to the first and/or second engagement means.

Preferably the second engagement means is a second clamping member. The clamping member is preferably an adjustable clamping member. The adjustable second clamping member may comprise opposed jaws. The opposed jaws may be resiliently biased to a closed opposition. The second clamping member may include screw threaded adjusting means for adjusting the jaws. Preferably the second clamping member includes locking means for locking the jaws into position. The locking means may be a lever activated over-centre locking means.

In one form, the second engagement means may be a permanent fixing to the ladder.

Preferably the second engagement member is a slide member for releasably engaging a side rail of the ladder. The slide member may be adapted to slidingly engage one or more adjustment rails located on a ladder rail. Preferably the slide member has position locking means for locking the slide member in a preferred position. The position locking means may be a screw thread operated device. The slide member may comprise a sleeve member adapted to slide over at least part of a perimeter of the ladder rail. The sleeve member may a slotted tube member. Alternatively the sleeve member may be an L shaped sliding member.

In one embodiment both the first engagement means and second engagement means are formed to slidingly engage the ladder rails, each to a respective rail and each further comprises gutter engagement means. The gutter engagement means may be a gutter engaging slot.

The second engagement means may be a u shaped member adapted to locate over the first and/or second structures or a feature thereof. The u shaped member may include screw operated locking means.

The second engagement means preferably further comprises length adjustment means for varying the length of operative connection member. The length adjustment means may be a buckle device. Alternatively, or additionally, the length adjustment means may be a retraction device.

Preferably the ladder stabilising device further comprises tensioning means for applying tension to the connection member. The tensioning means may comprise a ratchet and lever drum assembly or a tensioned drum adopted to retract the connection member.

In a second aspect, the invention resides in a method of stabilising a ladder, said method comprising:

fixing a first engagement means of a stabilising device to a first structure;

positioning a connection member of the stabilising device in a stabilising position adjacent a support structure, said support structure supporting an upper region of the ladder; and

fixing a second engagement means of the stabilising device to the first structure or a second structure.

The support structure may comprise the first or second structure or may be a separate structure supporting the upper ladder.

The method may include the step of positioning a bracket device to provide lateral stability to an upper region of the ladder.

The method may further include the step of tensioning the flexible connection member.

In one form the method includes the further step of sliding the second engagement means along a rail of the ladder to a suitable position and releasably fixing the second engagement means at that position.

The second engagement means is preferably a slotted sleeve, an L shape sleeve or adapted to cooperate with one or more adjustment rails located on a rail of the ladder.

### BRIEF DESCRIPTION OF THE DRAWINGS

FIG. 1 is a top view of a first embodiment of a ladder stabilising device of the present invention.

FIG. 2 is a perspective view of the ladder stabilising device of FIG. 1 in operation.

FIG. 3 is a perspective view of a second embodiment of a ladder stabilising device of the present invention in use.

FIG. 4 a front view of the arrangement of FIG. 3.

FIG. 5 is a perspective view of a third embodiment of a ladder stabilising device of the present invention in operation.

FIG. 6 is a perspective view of a fourth embodiment of a ladder stabilising device of the present invention.

FIG. 7 is a cross sectional view of the ladder rail of FIG. 6.

FIG. 8 is a perspective view of a tensioning device of FIG. 6.

FIG. 9 is a perspective view of a fifth embodiment of a ladder stabilising device of the present invention.

FIG. 10 is a top view of a variation of a second end of the ladder stabilising device of FIG. 9.

FIG. 11 is a front view of the device of FIG. 10.

FIG. 12 is a perspective view of a sixth embodiment of the ladder stabilising device of the present invention.

FIG. 13 is a front view of a ladder stabilising device in use.

### DETAILED DESCRIPTION OF THE DRAWINGS

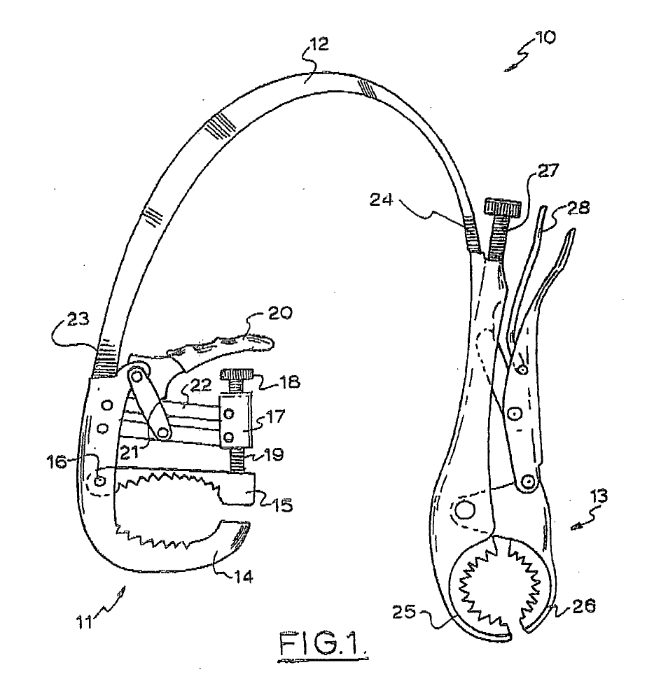

Throughout the description like numbers refer to like features. Referring to FIG. 1 there is seen a first embodiment of a ladder stabilising device 10 comprising a first engagement means in the form of first clamp 11, a connection member in the form of cable 12 and a second engagement means in the form of second clamp 13. First clamp 11 comprises first jaw 14 and second jaw 15 which are opposed. Second jaw 15 is hingedly mounted at pivot 16 so that it may be moved towards and away from the first jaw 14. A screw threaded adjustment device 17 is provided to permit rotation of disk 18 to advance or retract the threaded shaft 19 to position the jaws 14, 16 in contact with the structure to which the device is to be attached. The first clamp 11 also includes locking means in the form of a lever 20 which when depressed activates cam 21 to rotate tension bar 22 and thereby indirectly apply extra tension through the screw threaded adjusted device 17 onto the second jaw 15.

Clearly the first clamp 11 is well adapted to locate around a first structure such as a circular structure like a pipe or to be placed over the lip of a gutter or indeed to be located in operative position with any structure that will fit between its fully deployed jaws. It may be applied a ladder with which it is used.

The connection member 12 is shown as a cable in this view and it is permanently connected at a first end 23 to the first clamp 11. The cable 12 may be formed from any suitable material such as rubber, wire or rope or similar. A second end 24 is attached to the second clamp 13. The second clamp 13 is configured in this view in a different form to the first clamp 11i although this is not essential. The second clamp has opposed jaws 25, 26 which are moveable relative to each other and includes an initial adjustment device in the form of a threaded shaft 27 for providing an initial apposition of the jaws 25, 28 into contact with a structure to which they are attached. A further locking lever 28 is provided to pressurise the contact between the jaws and the structure to which they are in contact. The locking lever may activate a cam type locking device or any other suitable means known to a skilled addressee. The locking lever 28 may also act as a release lever to release tension in the device to permit its removal.

In operation, the first clamp 11 may be located on a suitable structure such as a gutter. Tine cable 12 may then be looped around an adjacent rail or rung of a ladder (or both) or indeed may be continued to encircle the rung or rail one or more times. The second clamp 13 may then be attached to the ladder itself, to the same structure as the first clamp 11 or to another structure which may be in the vicinity and suitable for receiving the second clamp 11. Application of the device is easy and quick and likewise its removal is easy facilitated. Both clamps may be fixed to the same structure or alternatively to separate structures. The clamps may be fixed to the ladder with the cable configured to wrap around any suitable fixed structure that will provide adequate support. That structure may be the structure which supports the upper region of the ladder or may be another suitable structure in the near vicinity.

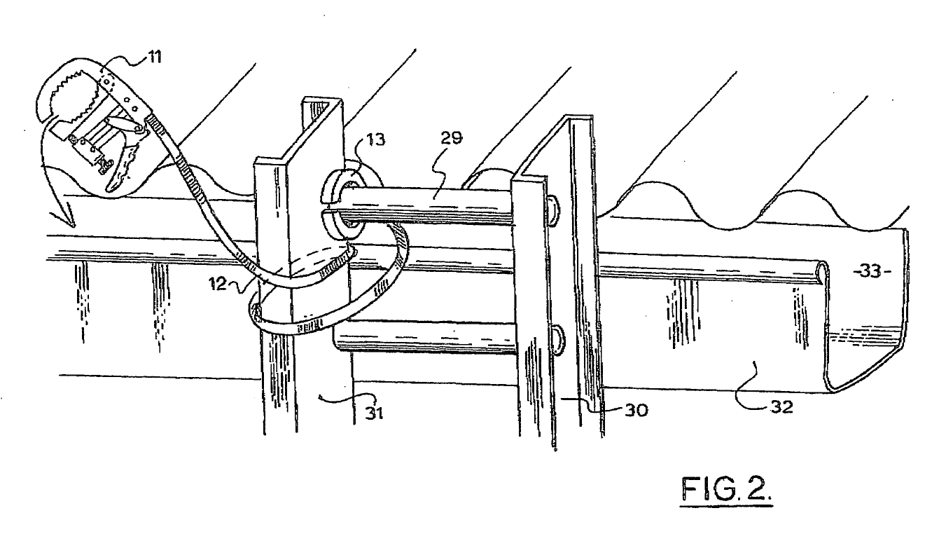

Operation of the device is seen in FIG. 2 where the second clamp 13 is clamped to a rung 29 which is supported by two spaced rails 30, 31. The cable 12 is looped around a side rail 31 and the first clamp 11 is aligned for positioning to engage an outer wall 32 of the gutter 33.

The first clamp 11 therefore forms first engagement means adapted to releasably engage a structure in the form of gutter 33 which is also a support structure for the upper region of the ladder. The cable 12 forms the flexible connection member which is positioned in a stabilising position adjacent the gutter 33. Adjacent in this specification includes a position which is in working proximity to the structure and may be any suitable operative distance. The cable 12 may be wrapped around the nearest rung or rail or at another more distant position which also provides a stabilising effect.

Alternatively, the first clamp 11 may be attached to the ladder, the cable 12 may be wrapped around the ladder and a supporting structure with the second clamp 13 also attached to the ladder.

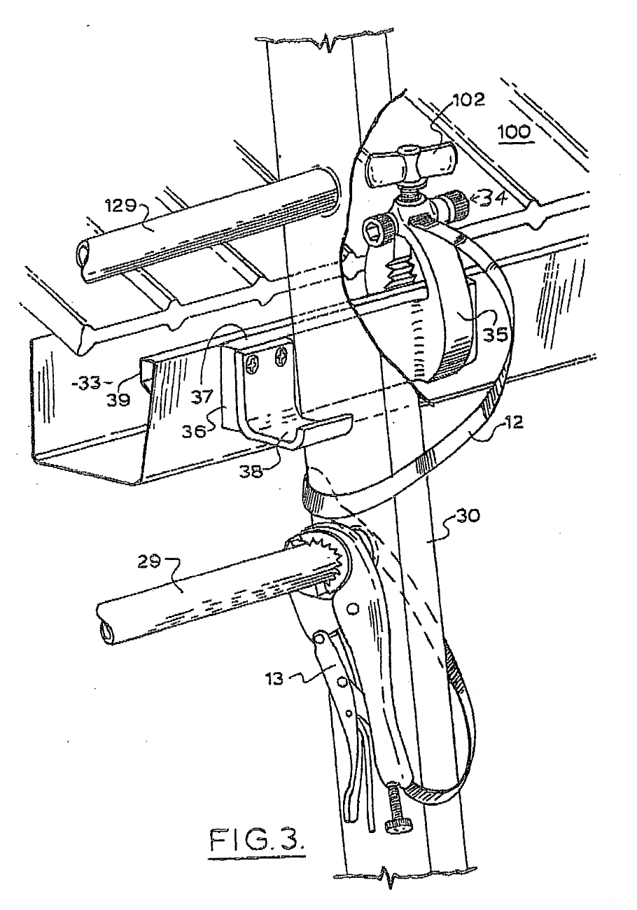

A second embodiment is seen in FIG. 3 wherein the second clamp 13 and cable 12 are substantially as described in FIG. 1. The cable 12 is located around side rail 30 and the clamp is attached to rung 29. The first clamp 34 however is modified so that a first jaw 35 cooperates with a bracket 36 to provide a lateral support member. The lateral support member comprises a plate member 37, tongue 38 and jaw 35 which together cooperate to provide a u shaped recess for location of the rail 30 thereby minimising the tendency for lateral displacement of the ladder. The first jaw 35, plate member 37 and tongue 38 may be formed integrally. Alternatively as shown in the present view some of the components may be formed separately and connected in any appropriate fashion. The bracket 36 may include a channel (not shown) location over a lip 39 of the gutter 33. The ladder rail 30 is shown in part section to better visualise the bracket 36. The gutter 33 is fixed under the overhang of roof 100. An additional rung 129 is also shown and highlights the versatility of the ladder stabilising device which can be located at any convenient position along the length of the ladder and not necessarily only restricted to the top end of the ladder. In some circumstances, the ladder stabilising device may be located centrally or thereabouts on the ladder. The ladder stabilising device may be stored by attachment to the ladder itself, conveniently on a low rung or around a rail so it is always to hand when required.

A further advantage of the adjustable clamp 13 is that it is positioned adjacent the ladder rail 30 and substantially parallel to it. This ensures that the chance of a user tripping or stumbling on the clamp 13 is minimised.

The bracket 36 has a threaded shaft and finger operated flange 102 for tensioning the clamping jaws of the device.

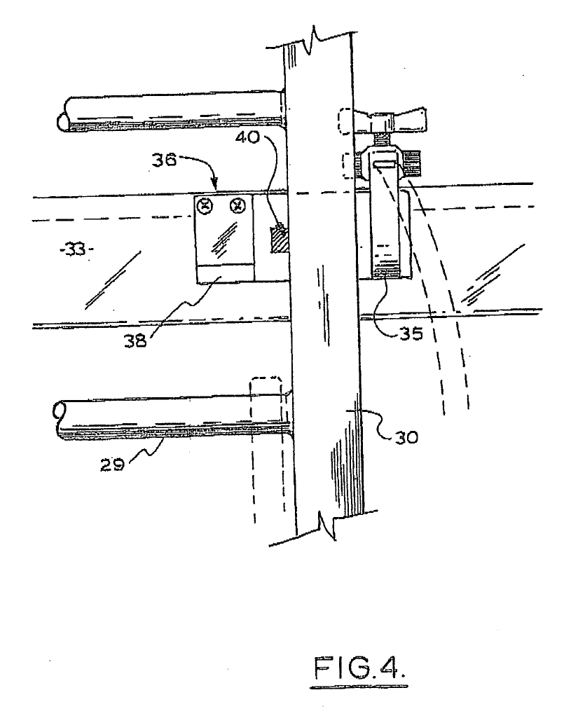

FIG. 4 shows a front view of the arrangement of FIG. 3 which highlights a sliding capacity formed by slot 40 in the bracket 36 which allows differential movement of the tongue 38 and first jaw 35 to thereby conform the gap provided in the bracket more closely to the width of the rail 30.

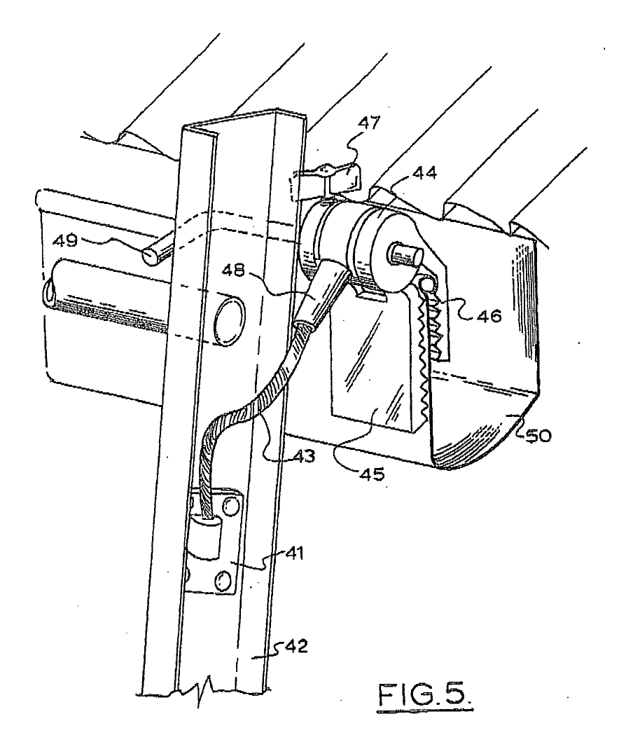

FIG. 5 shows a further embodiment of the ladder stabilising device in which the second engagement means is a plate 41 permanently fixed to a u shaped rail 42 of a ladder. A strap like connection member 43 is connected to a first clamp 44 comprising opposed jaws 45, 46 having a first screw threaded tensioning bolt 47 and a looking means actuated by a lever handle 48 which is rotatable into contact or near contact with the first opposed jaw 45 to lock the device in place. The first clamp 44 includes an adjustable wire bracket 49 which together with the lever 48 and jaw 45 forms a lateral support member. The adjustable wire bracket 49 is slidingly engaged in a bore (not shown) in the first clamp 44 and may be locked in position by rotation of the threaded bolt 47. The first clamp 44 is shown in locking engagement with gutter 50.

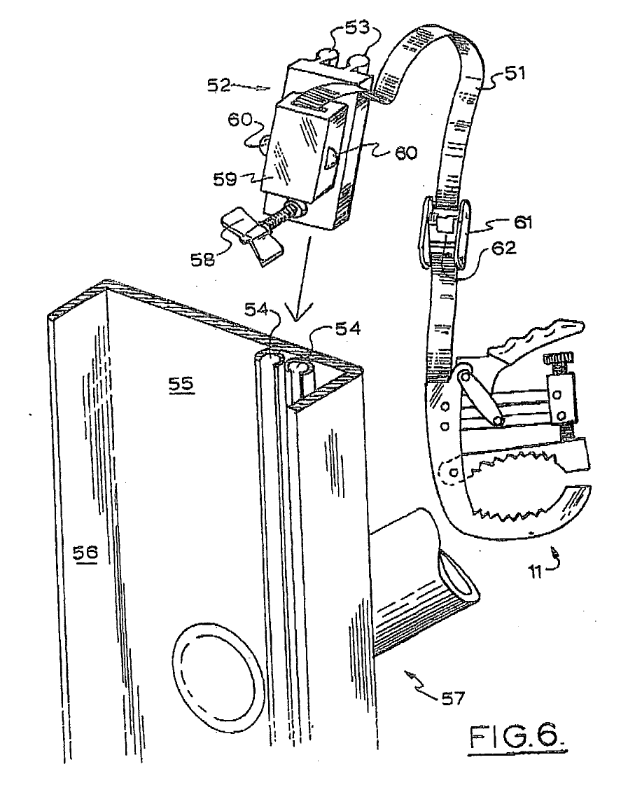

FIG. 6 shows yet a further embodiment of a ladder stabilising device 14 of the present invention comprising a first clamp 11, a strap 51 and second engagement means in the form of slide member 52. The slide member 52 has paired runners 53 located on a bottom surface of the slide member 52 and adapted to engage and slide along corresponding rails 54 located on an outer wall 55 of a side rail 56 of the ladder 57. The slide member 52 can therefore slide up and down the rails 54 until located in a suitable position at which stage the looking means in the form of wing nut screw 58 may be operated to lock the slide member 52 in position relative to the side rail 56.

The slide member 52 also includes a length adjustment device in the form of a tensioned retraction mechanism located under housing 59. A suitable mechanism may be similar to those used in inertia reel seat belts which provide the ability to lengthen the strap 61 and use a rotatable cam to lock the device when subject to a sudden force. The present embodiment also includes release tabs 60 which may be depressed to release the retraction mechanism and thereby retract the strap 51.

The ladder stabilising device also includes a further length adjustment device in the form of buckle 61 which may be used to shorten the length of the strap 51. This embodiment further includes a tensioning means in the form of ratchet and lever rotating drum assembly 62 explained below in relation to FIG. 8.

The connection member may be formed as a single belt or cord. Alternatively a plurality of parallel or even crossed elongate members may be used to form the connection member.

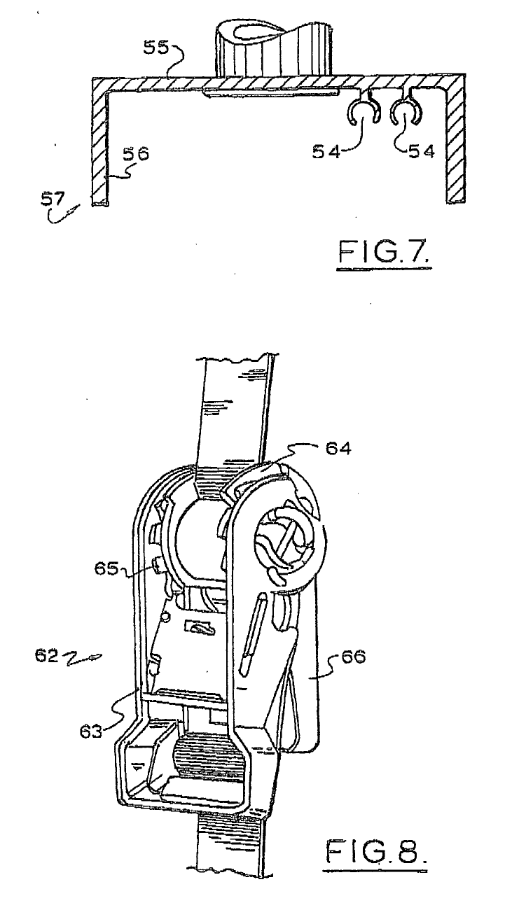

FIG. 7 is a cross sectional view of the side rail 56 of ladder 57 showing the rails 54 formed as raised runners with slots to engage the paired runners 53 of the slide member 52. Other arrangements may be utilised.

FIG. 8 shows a perspective view of the ratchet and lever assembly 62 formed by a base 63, a drum 64, ratchet mechanism 65 and lever 66. In use the lever 66 is pumped to rotate the drum 64 which is maintained in position by the ratchet mechanism 65. Once suitable tension is obtained the lever 66 may be pushed into apposition with the base 63 to lock the device. The device also includes a release mechanism (not shown) to allow lengthening of the strap 51 for removal or subsequent use.

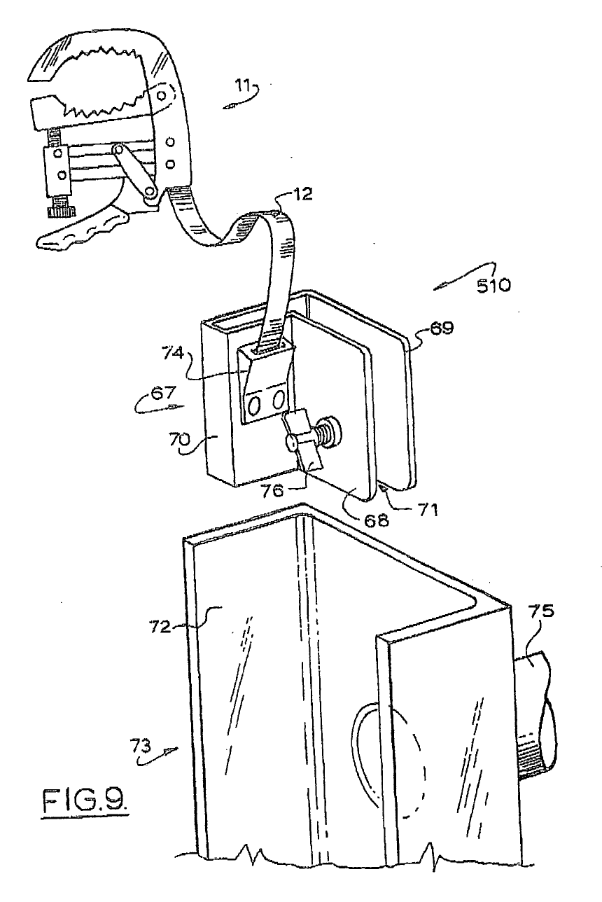

FIG. 9 shows a further embodiment of a ladder stabilising device 510 comprising an L shaped slot member 67 formed by a first L shaped plate member 68 and second L shaped plate member 69 spaced by an intermediate wall 70. The L shaped slide member has an internal channel 71 dimensioned to located around the side rail 72 of a ladder 73. A cable or strap 12 is attached to the slide member 67 at ledge 74 and is fixed at its other end to first clamp 11. The L shaped slide member 67 is formed to avoid a rung 75 in operation and may be slid into position where it is locked by operation of the lock screw 76.

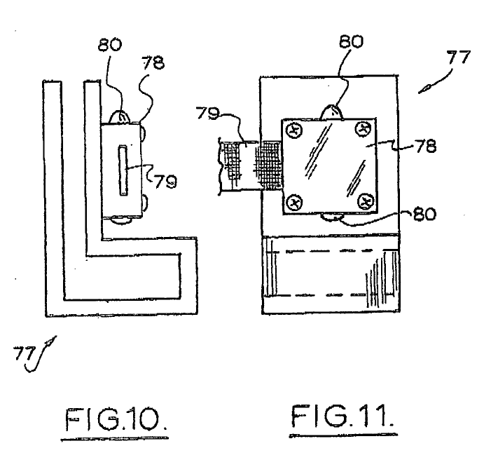

FIG. 10 shows a top view of a variation of the slide member of FIG. 9. This slide member 77 is also L shaped but has a housing 78 containing a retraction device (not shown) to tension the strap 79 and also to withdraw the strap into a storage position. Release tabs 80 are also visible which may be depressed to release the strap 79 for retraction or lengthening. A side view of the device of FIG. 10 is seen in FIG. 11 with the strap 79 protruding from housing 78 all supported on the slide member 77.

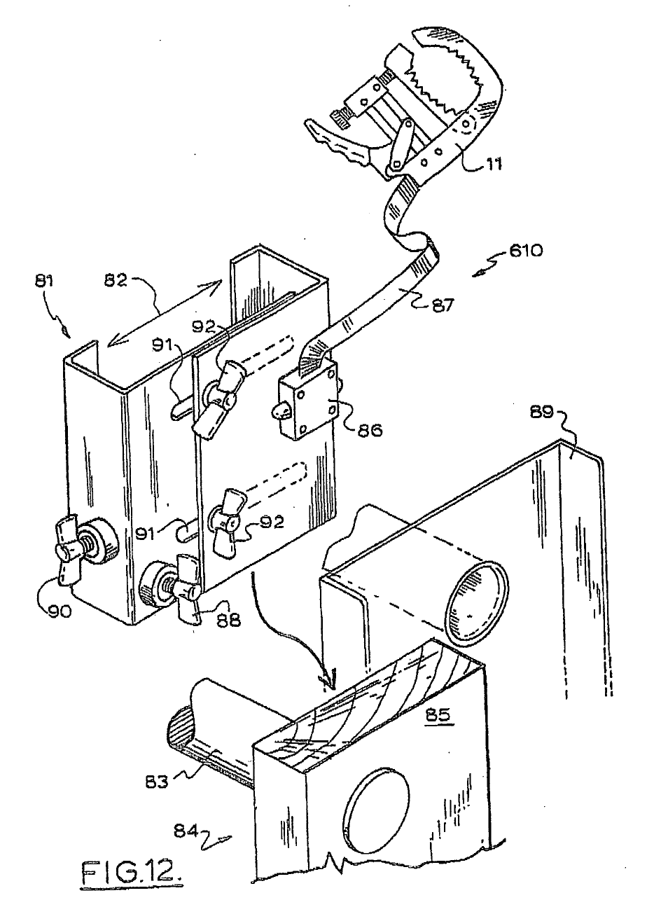

FIG. 12 shows a variation on the slide member principle. The ladder stabilising device 610 is shown comprising a sleeve member 81 having a slot 82 dimensioned to clear rungs 83 of a ladder 84. The sleeve member 81 covers a substantial proportion of the side rail 85 of the ladder 84. The sleeve member 81 also has a housing 86 with a retraction mechanism for the belt 87 which is attached to the first clamp 11. The sleeve member 81 may be slid into position on the side rail 85 and locked in position by activation of locking screw 88. This version of the sleeve member may also be used on a u shaped rail 89. However, its position may also be locked by activation of second lock screw 90. The sleeve member 81 has an additional advantage in adjustment slots 91 which permit adjustment of the width of the sleeve member to better conform to the dimensions of a rail with which it is engaged. The slot locking screws 92 may be released and two halves of the sleeve member 81 slid towards or away from each other prior to retightening of the slot locking screws in the new chosen dimension.

In an alternative embodiment (not shown), the first and second clamping members may be formed as slide members to each engage a separate rail of the ladder. The two members may be formed by a rigid or semi-rigid connection member. Each slide member may include a u or v shaped recess to locate over the outer wall or a roll of a gutter. The recess may be padded.

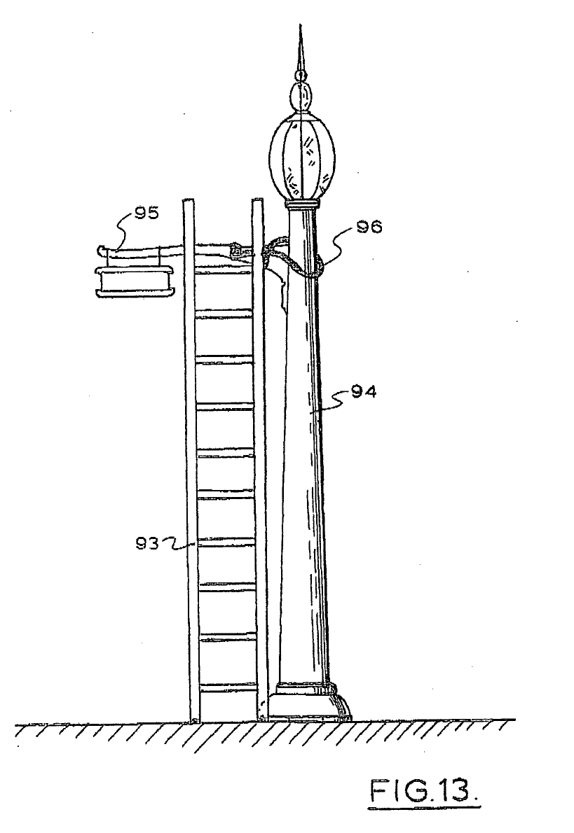

FIG. 13 shows a ladder 93 in position adjacent a light pole 94 and resting on an arm 96 of the pole 94. A ladder stabilising device 96 is shown in operative position located around the pole 94 and locked to the ladder 93 and also providing lateral stability against sliding displacement of the ladder.

The advantages of the present invention are readily apparent. It may be formed as a relatively light weight device which can be easily carried by a person climbing a ladder. The device may be quickly and effectively located to fix and stabilise the upper section of the ladder. The point of stabilisation may be adjacent an end of the ladder or indeed may be a position intermediate the ends but which is conveniently close to a structure suitable for accepting the locking mechanisms of the device. The adjustment capacity described in the preferred embodiments allows great versatility providing the ability to loop around a rail or a rung or both prior to fixing to a suitable support structure. A further utility is provided in that the ladder stabilising device may be fixed to the ladder when it is not in operation so that it is permanently available to the user of the ladder while providing the option to be left in place in circumstances when it is not required. The ladder stabilising device may be expected to be relatively cheaply produced and readily available for use both in domestic and industrial situations. Its use may resist and some circumstances negate risk of ladder instability during use. It is preferred that the ladder stabilising device be formed from strong and weather resistant materials. It is envisaged also that seat belt material may be particularly suitable for use in this device. The range of embodiments provides the ability for fitting of the device to existing ladders. New ladders may be formed with the rails necessary for the embodiment of FIG. 6 formed integrally as part of the extrusion of the side rail material.

Throughout the specification the aim has been to describe the preferred embodiments of the invention without limiting the invention to any one embodiment or specific collection of features. Those of skill in the art will therefore appreciate that, in light of the instant disclosure, various modifications and changes can be made in the particular embodiments exemplified without departing from the scope of the present invention. All such modifications and changes are intended to bs included within the scope of the disclosure.

1. A ladder stabilising device comprising:
first engagement means adapted to releasably engage a first structure;
an elongate connection member connected to the first engagement means; and
second engagement means adapted to engage the first structure or a second structure, the second engagement means connected to the connection member at a position spaced from the first engagement means.

2. The ladder stabilising device of claim 1 wherein the connection member is at least partially flexible.

3. The ladder stabilising device of claim 2 wherein the first engagement means is a clamping member.

4. The ladder stabilising device of claim 3 wherein the clamping member has opposed jaws movable relative to each other.

5. The ladder stabilising device of claim 4 wherein the clamping member further includes locking means for releasably locking the jaws in pressured contact with the structure.

6. The ladder stabilising device of claim 3 wherein the clamping member further comprises a lateral support member, said lateral support member adapted to resist lateral movement of a ladder rail in use.

7. The ladder stabilising device of claim 6 wherein the lateral support member is a bracket member adapted to receive a ladder rail in a recess.

8. The ladder stabilising device of claim 7 wherein a width of the recess is adjustable.

9. The ladder stabilising device of claim 6 wherein the lateral support member is continuous with one of the jaws.

10. The ladder stabilising device of claim 3 wherein the clamping member includes a recess for location over the structure or part thereof and a threaded shaft screwable in pressured contact with the structure or part thereof, thereby clamping the first engagement means in position.

11. The ladder stabilising device of any preceding claim wherein the connection member is flexible throughout its length.

12. The ladder stabilising device of claim 11 wherein the connection member is strap like.

13. The ladder stabilising device of claim 11 wherein the connection member is circular in cross section.

14. The ladder stabilizing device of claim 11 wherein the connection member is elastic.

15. The ladder stabilising device of claim 1 wherein the second engagement means is a second clamping member.

16. The ladder stabilising device of claim 15 wherein the second clamping member has opposed jaws, movable relative to each other.

17. The ladder stabilising device of claim 16 wherein the opposed jaws are resiliently biased to a closed position.

18. The ladder stabilising device of claim 17 further comprising scow threaded adjustment means for adjusting the jaws and locking means for releasably locking the jaws into position.

19. The ladder stabilising device of claim 1 wherein the second engagement means is a slide member for adjustably engaging a side rail of a ladder.

20. The ladder stabilising device of claim 20 wherein the slide member is adapted to slidingly engage one or more adjustment rails located on a ladder roil.

21. The ladder stabilising device of claim 19 wherein the slide member comprises a sleeve member adapted to slide over part of a perimeter of the side rail.

22. The ladder stabilising device of claim 21 wherein the sleeve member is L shaped.

23. The ladder stabilising device of claim 21 wherein the sleeve member is a slotted tube.

24. The ladder stabilising device of claim 22 wherein the width of the sleeve member is adjustable.

25. The ladder stabilising device of any one of claims 19 to 24 further comprising a lock device for releasably locking the slide member in an operative position.

26. The ladder stabilising device of claim 1 wherein each of the engagement means is a slide member adapted to slide along a respective rail of a ladder, each of the slide members attached to the other by a rigid or semi-rigid connection member and each slide member further comprising a gutter engaging means.

27. The ladder stabilising device of claim 1 wherein the second engagement means is permanently fixed to a ladder.

28. The ladder stabilising device of claim 1 wherein the second engagement means further comprises length adjustment means for varying the length of operative connection member.

29. The ladder stabilising device of claim 28 wherein the length adjustment means is at least one of a buckle device and a retraction device.

30. The ladder stabilising device of claim 1 further comprising tensioning means for applying tension to the connection member.

31. The ladder stabilising device of claim 30 wherein the tensioning means comprises one or more of a ratchet and drum assembly and a tensioned retraction drum.

32. A ladder stabilising system comprising:
a first engagement member adapted to releasably engage a structure;
a flexible connection member connected to the first engagement member;
a slide member adapted to slide along a rail of a ladder;
locking means for releasably fixing the slide member in position relative to the ladder rail; and
the ladder.

33. The ladder stabilising system of claim 32 wherein the slide member and ladder rail are engageable by a slot and rail arrangement.

34. The ladder stabilising system of claim 33 wherein the ladder has two lengthwise disposed parallel rails or slots adapted to engage corresponding slots or rails respectively on the slide member.

35. A method of stabilising a ladder comprising the steps of:
releasably fixing a first engagement means to a first structure;
positioning a connection means to enclose at least one side rail or rung of a ladder, said connection means connected to the first engagement means; and
fixing a second engagement means to the first structure or a second structure, the second engagement means connected to the connection member and spaced from the first connection means.

36. The method of claim 35 further including the step of positioning a bracket device to provide lateral stability to a ladder rail when in use.

37. The method of either one of claims 35 or 36 wherein fixing the second engagement means comprises the step of releasably fixing the second engagement means to the ladder.

38. The method of claim 37 wherein releasably fixing the second engagement means to the ladder comprises the step of slidingly engaging the second engagement means with the ladder.

39. The method of claim 38 wherein the step of slidingly engaging the second engagement means with the ladder comprises the step of engaging a slide member with the ladder by a slot and rail arrangement.

40. The method of any one of claims 38 or 39 further comprising adjusting looking means to releasably fix the second engagement means in position relative to the rail.

41. The method of any one of claims 35 to 40 further comprising the step of tensioning the flexible connection member.

42. A ladder stabilising device substantially as herein described with reference to the figures.
